(19) United States
(12) Patent Application Publication
(10) Pub. No.: US 2016/0223643 A1
(43) Pub. Date: Aug. 4, 2016

(54) Deep Fusion of Polystatic MIMO Radars with The Internet of Vehicles for Interference-free Environmental Perception

(71) Applicants: Wenhua Li, Auburndale, MA (US); Min Xu, Auburndale, MA (US)

(72) Inventors: Wenhua Li, Auburndale, MA (US); Min Xu, Auburndale, MA (US)

(21) Appl. No.: 14/975,755

(22) Filed: Dec. 19, 2015

Related U.S. Application Data
(60) Provisional application No. 62/108,608, filed on Jan. 28, 2015.

(51) Int. Cl. G01S 7/02; G01S 13/00

(52) U.S. Cl. CPC G01S 7/023; G01S 13/003

(57) ABSTRACT

This invention is related to a deep multi-sensor fusion system for inter-radar interference-free environmental perception comprising of (1) polystatic Multi-Input Multi-Output (MIMO) radars such as radio frequency radar and laser radar; (2) vehicle self-localization and navigation; (3) the Internet of Vehicles (IoV) including Vehicle-to-Vehicle communication (V2V), Vehicle-to-Infrastructure communication (V2I), other communication systems, data center/cloud; (4) passive sensors such as EOIR, and (5) deep multi-sensor fusion algorithms. The self-localization sensors and V2X formulate cooperative sensors. The polystatic MIMO radar on each vehicle utilizes both its own transmitted radar signals and ones from other vehicles to detect obstacles. The transmitted radar signals from other vehicles are not considered as interference or uselessness as conventional radars, but considered as useful signals to formulate a polystatic MIMO radar which can overcome the interference problem and improve the radar performance. This invention can be applied to all kinds of vehicles and robotics.

### TECHNICAL FIELD

This invention relates to a deep fusion system of polystatic MIMO radars with the Internet of Vehicles (IoV), which can provide inter-radar interference-free environmental perception to enhance the vehicle safety.

### BACKGROUND OF THE INVENTION

Advanced Driver Assistance Systems (ADAS)/self driving is one of the fastest-growing fields in automotive electronics. ADAS/self-driving is developed to improve the safety and efficiency of vehicle systems. There are mainly three approaches to implement ADAS/self-driving: (1) non-cooperative sensor fusion; (2) GPS navigation/vehicle-to-X networks used as cooperative sensors; (3) fusion of non-cooperative and cooperative sensors.

More and more vehicles are being equipped with radar systems including radio frequency (RF) radar and laser radar (LIDAR) to provide various safety functions such as Adaptive Cruise Control (ACC), Forward Collision Warning (FCW), Automatic Emergency Braking (AEB), and Lane Departure Warning (LDW), autonomous driving. In recent years, integrated camera and radar system has been developed to utilize the advantages of both sensors. Because of the big size and high price, LIDAR is less popular than RF radar in the present market. With the development of miniaturized LIDAR, it will become another kind of popular active sensors for vehicle safety applications.

One advantage of RF radars and LIDAR is that they can detect both non-cooperative and cooperative targets. However, although RF radar is the most mature sensor for vehicle safety applications at present, it has a severe shortcoming: inter-radar interference. This interference problem for both RF radar and LIDAR will become more and more severe because eventually every vehicle will be deployed with radars. Some inter-radar interference countermeasures have been proposed in the literature. The European Research program MOSARIM (More Safety for All by Radar Interference Mitigation) summarized the radar mutual interference methods in detail. The domain definition for mitigation techniques includes polarization, time, frequency, coding, space, and strategic method. For example, in the time domain, multiple radars are assigned different time slots without overlapping. In the frequency domain, multiple radars are assigned different frequency band.

The radar interference mitigation algorithms in the literature can solve the problem to some extent. Because of the frequency band limit, the radar interference may be not overcome completely, especially for high-density traffic scenarios. Shortcomings of the present proposed solutions are: (1) The radar signals transmitted from other vehicles are considered as interference instead of useful information; (2) Internal radar signal processing is not aided by cooperative sensors; (3) Multi-sensor is not fused deeply with the Internet of Vehicles (IoV).

IoV is another good candidate technique for environmental perception in the ADAS/self-driving. All vehicles are connected through internet. The self-localization and navigation module onboard each vehicle can obtain the position, velocity, and attitude information by fusion of GPS, IMU, and other navigation sensors. The dynamic information, the vehicle type, and sensor parameters may be shared with Vehicle-to-Vehicle (V2V) and Vehicle-to-Infrastructure (V2I) communication systems. Some information such as digital map and the vehicle parameters and sensor parameters may be stored in the data center/cloud. This is a cooperative approach. However, it will fail in detecting non-cooperative obstacles. So navigation/V2X cannot be used alone for obstacle collision avoidance.

This invention proposes a new approach to utilize multiple dissimilar sensors and IoV. Radars are deeply fused with cooperative sensors (self-localization/navigation module and V2X) and other onboard sensors such as EOIR. The transmitted radar signals from other vehicles are not considered as interference anymore, but considered as useful information to formulate one or multiple polystatic MIMO radars which can overcome the interference problem and improve the radar detection and tracking performance. Multiple polystatic MIMO radars may be formulated along different directions such as forward-looking, backward-looking and side-looking.

### SUMMARY

This invention is related to a deep multi-sensor fusion system for inter-radar interference-free environmental perception, which consists of (1) polystatic MIMO radars such as RF radar and LIDAR; (2) vehicle self-localization and navigation; (3) the IoV including V2V, V2I, other communication systems, and data center/cloud; (4) passive sensors such as EOIR, (5) deep multi-sensor fusion algorithms; (6) sensor management; and (7) obstacle collision avoidance.

Conventionally the transmitted radar signals from other vehicles are considered as interference, and a few mitigation algorithms have been proposed in the literature. However, this invention utilizes these transmitted radar signals from other vehicles in a different way. Radar signals from other vehicles are used as useful information instead of interference. The radars on own platform and on other vehicles are used together to provide a polystatic MIMO radar. If there are no other vehicles such as in very sparse traffic, no radar signals from other vehicles are available, then this radar works in a mono-static approach. If there are MIMO elements on its own vehicle, it is a monostatic MIMO radar. If there is another vehicle equipped with a radar, both radars work together as a bistatic MIMO radar. If there are multiple vehicles equipped with radars, it works as a multistatic MIMO radar. It may also work in a hybrid approach. The transmitters on different vehicles may be synchronized with the aid of GPS, network synchronization method, or sensor registration. The residual clock offset can be estimated by sensor registration.

In order to deeply fuse radars from all vehicles nearby, it is necessary to share some information between all these vehicles. The self-localization and navigation information for each vehicle is obtained through fusion of GPS, IMU, barometer, visual navigation, digital map, etc., and is transmitted to other vehicles through the communication systems in the IoV. The self-localization sensors and V2X forms cooperative sensors. Other vehicle information such as vehicle model and radar parameters is also broadcasted, or obtained from the cloud. The polystatic MIMO radar on each vehicle utilizes both its own transmitted radar signals and ones from other vehicles to detect obstacles.

Deep fusion means that the internal radar signal processing algorithms are enhanced with the aid of cooperative sensors. The typical radar signal processing modules include matched filter, detection, range-doppler processing, angle estimation, internal radar tracking, and association. Conventional radar signal processing is difficult to mitigate inter-radar interference because the radar parameters and vehicle information are not shared between vehicles. The radar is fused shallowly with other sensors and/or IoV. The own radar only uses its own transmitted signals. With the aid of IoV, each radar signal processing module can be done more easily with higher performance.

This invention can be applied not only to the advanced driver assistance systems of automobiles, but also to the safety systems of self-driving cars, robotics, flying cars, unmanned ground vehicles, and unmanned aerial vehicles.

### BRIEF DESCRIPTION OF THE DRAWINGS

The present invention may be understood, by way of examples, to the following drawings, in which:

FIG. 1 is a top view of the deep fusion system of polystatic MIMO radars with the internet of vehicles for inter-radar interference-free environmental perception.

FIG. 2 is a block diagram showing the internet of sensors and vehicles for obstacle detection.

FIG. 3 illustrates the payload of vehicles including sensors and V2X.

FIG. 4 shows the typical triangular modulation waveforms of single FMCW radar.

FIG. 5 shows the triangular modulation waveforms of multiple TDMA FMCW radars.

FIG. 6 shows the triangular modulation waveforms of multiple FDMA FMCW radars.

FIG. 7 shows the beamforming of single SDMA FMCW radar.

FIG. 8 shows the co-frequency triangular modulation waveforms of multiple FMCW radars.

FIG. 9 is a monostatic approach for vehicle radars.

FIG. 10 is a bistatic approach for vehicle radars.

FIG. 11 is a multistatic approach for vehicle radars.

FIG. 12 is the polystatic approach for vehicle radars. The polystatic radar may work in any one of, or combination of, these approaches.

### DETAILED DESCRIPTION OF THIS INVENTION

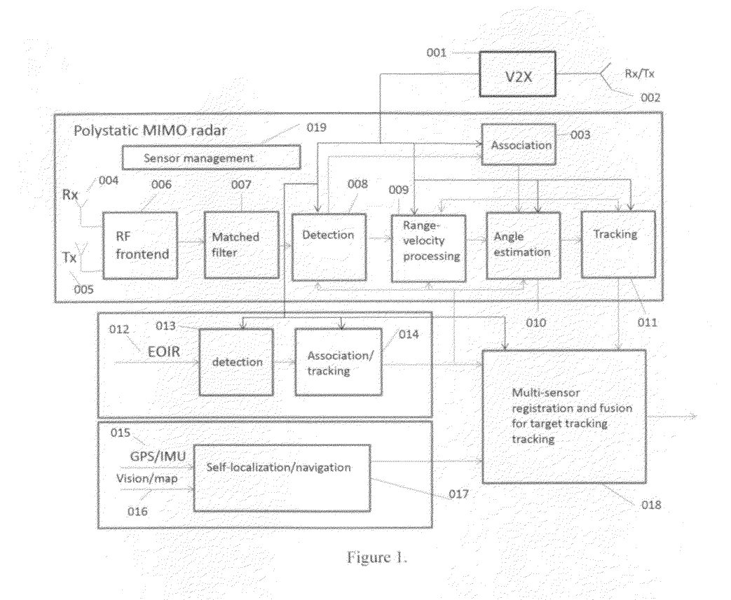

FIG. 1 shows the block diagram of the deep fusion system of polystatic MIMO radars with the internet of vehicles for inter-radar interference-free environmental perception. The deep fusion system on each vehicle mainly consists of: (1) polystatic MIMO radar: Receiver antenna 004, transmitter antenna 005, RF/LIDAR frontend 006, data association 003, matched filter 007, detection 008, range-doppler processing 009, angle estimation 010, tracking 011. For different radar types, the polystatic MIMO radar may have different sub-modules; (2) Passive EOIR subsystem: EOIR sensor 012, detection 013, tracking 014; (3) Self-localization/navigation subsystem: GPS/IMU 015, vision/map 016, self-localization/navigation algorithm 017; (4) Internet of Vehicles: V2X (V2V and V2I) 001, transmitter/receiver antenna 002; (5) multi-sensor registration and fusion module 018; (6) Sensor management module 019 which manages the sensor resources including time/frequency/code resources, power control, etc.; (7) Obstacle collision avoidance module 20; (8) V2X or cloud infrastructure connected with this own vehicle 021. Other modules on vehicles may be included such as sonar. Only one polystatic MIMO radar is shown in FIG. 1. Actually there may be a few polystatic MIMO radars for each direction such as forward-looking, backward-looking, and side-looking.

The basic flowchart of the deep fusion system is explained as follows: The self-localization/navigation module on another vehicle estimates its dynamic states such as position, velocity, and attitude. This information together with vehicle type, sensor parameters is shared with vehicles nearby through V2X. There are single or multiple transmitter antennas. Multiple receiver antennas receive not only own signals reflected from targets, but also receive signals from radars on other vehicles. There are two purposes of the cooperative sensors based on navigation/V2X: (1) The cooperative sensors are fused with other sensors on its own platform such as EOIR, GPS, IMU, digital map, etc. This is the conventional shallow fusion approach; (2) The cooperative sensors are used as an aid to improve the performance of internal radar signal processing; (3) The imaging tracking subsystem is also deeply fused with the radars. This is the deep fusion approach. Because of the accurate localization information from GPS/IMU, etc, the internal radar signal processing modules such as detection, range-doppler processing, angle estimation, tracking, can easily process cooperative targets. After processing the cooperative targets, the number of non-cooperative obstacles left will be reduced greatly. The multiple radars from different vehicles formulate a polystatic MIMO radar with higher performance. Because all radar signals are used as helpful information, the conventional inter-radar interference problem is completely overcome; (4) The sensor management module is responsible for the management of radar resources such as frequency band, time slots, power control, etc. If the total number of frequency bands, time slots, and orthogonal codes is larger than the total number of radars around some coverage, orthogonal waveforms can be assigned to each radar. Otherwise, some radars will be assigned with the same frequency band, time slot and orthogonal code.

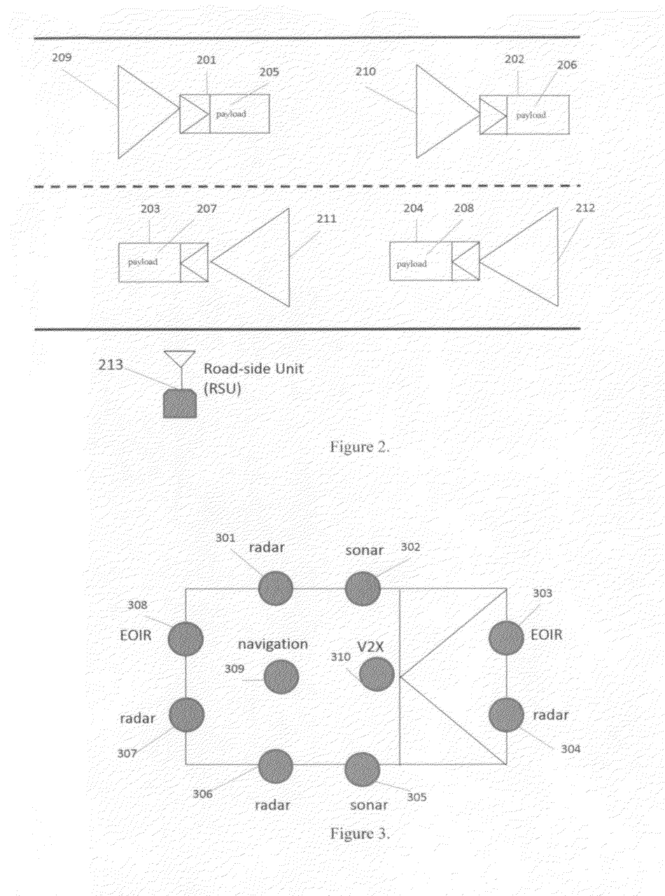

FIG. 2 is a block diagram showing the internet of sensors and vehicles for obstacle detection. There are 4 vehicles nearby 201 202 203 204. The detailed algorithm of the payload on each vehicle 205 206 207 208 is shown in FIG. 1. The antenna beam pattern for each vehicle is shown as 209 210 211 212.

FIG. 3 illustrates the payload of vehicles including sensors and V2X including side-looking radars 301 306, side-looking sonars 302 305, forward-looking radar 304, forward-looking EOIR 303, backward-looking radar 307, back-looking EOIR 308, navigation 309, V2X 309. Each radar may be used to formulate a polystatic MIMO radar by deeply fusing with other radar signals.

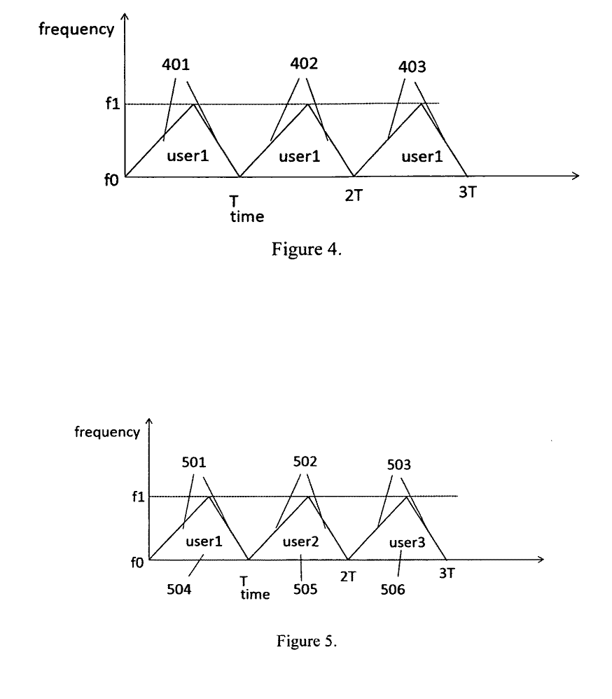

This invention is suitable for different radar waveforms. Here we use the Frequency Modulation Continuous Wave (FMCW) radar waveforms as an example. FIG. 4 shows the typical triangular modulation waveforms of single FMCW radar. The performance of the original FMCW radar is very good for tracking single target, with low computational complexity, low cost, and low power consumption. The frequency of the radar carrier is modulated as a triangular waveform. After Fast Fourier Transform (FFT) and Constant False Alarm Rate (CFAR) detection, the beat frequencies are estimated. Then the distance to the target and its relative velocity can be calculated using closed-form equations.

The single triangular FMCW waveform is poor at detecting multiple targets. Some modified FMCW radar waveforms have been proposed in the literature such as three-segment FMCW waveform. FIG. 5 shows the triangular modulation waveforms of multiple Time Division Multiple Access (TDMA) FMCW radars. The first triangular waveforms 501 502 503 are assigned to user 1 504, user 2 505, and user 3 506, respectively. Because multiple FMCW radars use different time slots, there is no inter-radar interference problem if the number of time slots is bigger than the radar number. But the number of time slots is limited.

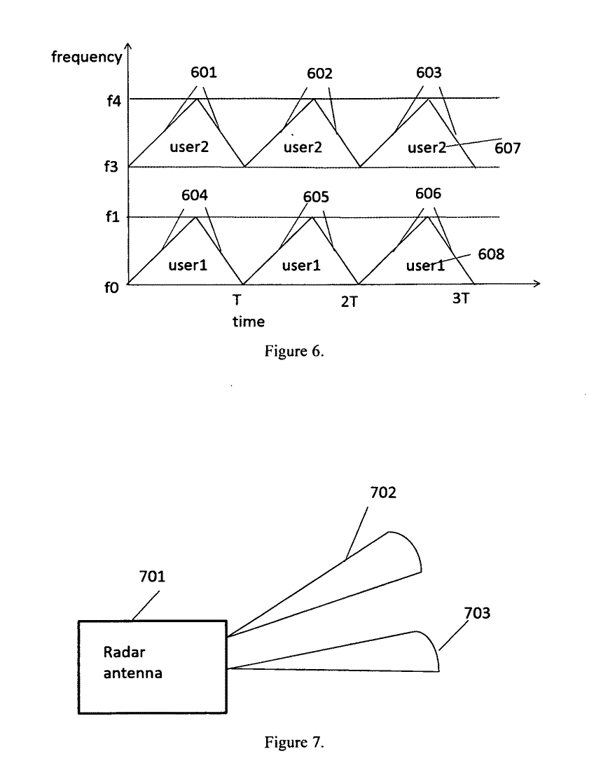

FIG. 6 shows the triangular modulation waveforms of multiple Frequency Division Multiple Access (FDMA) FMCW radars. Both radar users (user 1 608, user 2 607) transmit radar signals at the same time and continuously. But their carrier frequencies are different. The frequency band [f0, f1] is assigned to radar 1 608 while the frequency band [f3, f4] is assigned to radar 2 607. Because two radars have different frequency bands, there is no inter-radar interference problem if the number of available frequency bands is larger than the radar number. The frequency band assigned to automotive radars is also limited.

FIG. 7 shows the beamforming of single FMCW radar for mitigating inter-radar interference through Space Division Multiple Access (SDMA). Beamforming can null the interference along some directions.

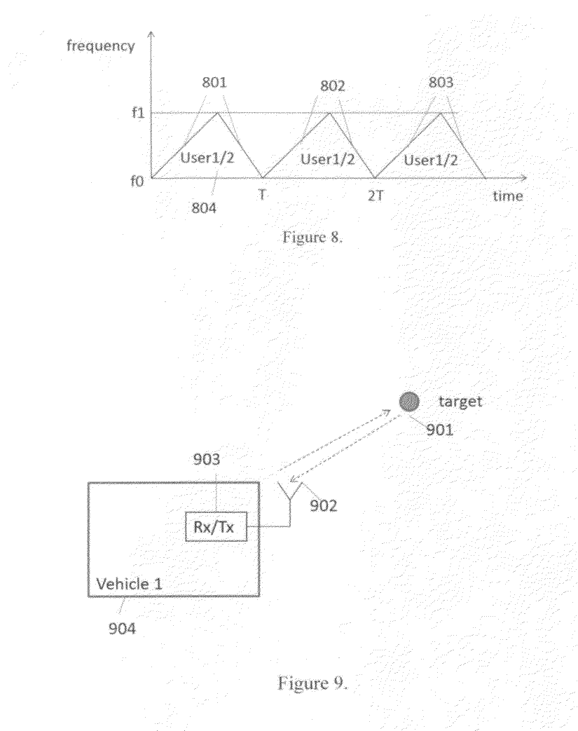

FIG. 8 shows the co-frequency triangular modulation waveforms of multiple FMCW radars. User1 (radar1) and user2 (radar2) 804 are both assigned the same frequency band [f0, f1]. And both radars transmit signals continuously. Traditional FMCW radars will fail if they use the same frequency band at the same time under multiple targets scenarios. This problem can be overcome by deeply fusing the FMCW radars with the cooperative sensors formulated with the aid of IoV. Two FMCW radars with the same frequency band at the same time will formulate a distributed bistatic MIMO radar.

FIG. 9 is a monostatic approach for vehicle radars. This is the main working approach for the FMCW radars in the present market. The transmitter and receiver antennas are co-located. If there is no other FMCW radars nearby (such as sparse traffic scenarios), the polystatic MIMO radar without fusion with cooperative sensors will be reduced to the conventional radar approach.

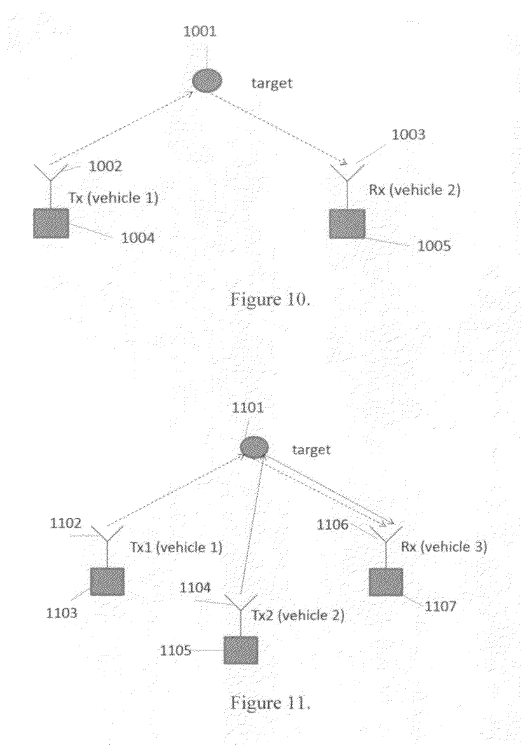

FIG. 10 is a bistatic approach for vehicle radars. The radar transmitter 1004 is on vehicle 1, and the radar receiver 1005 is on vehicle 2. If the radar transmitter on radar 21005 also use the same frequency band and time slots as the radar on vehicle 1 1004, both radars will interfere with each other by conventional approach. Through the IoV and self-localization/navigation, the state of vehicle 1 is shared with vehicle 2. So a bistatic radar approach is formed. The relative velocity and distance between two vehicles from cooperative sensors are available on vehicle 2 1005. Time synchronization between vehicles may be obtained through GPS and other network synchronization methods. The residual clock offset between vehicles is estimated by the multi-sensor registration module 018. By using the relative velocity and distance from the cooperative sensors and the clock offset estimation, we can easily find out which peak in the spectrum after FFT is from this bistatic subsystem. No matter the radar waveforms on vehicle 1 and vehicle 2 are orthogonal or the same, the cooperative, internet-connected vehicle will be detected by combination of monostatic and bistatic approaches. After all cooperative vehicles are detected from the FFT spectrum, other peaks are from non-cooperative vehicles. As for the radar detection of non-cooperative vehicles or obstacles, EOIR can be deeply fused with radar detection. The state of detected non-cooperative vehicles may also be broadcasted through IoV.

FIG. 11 is a multistatic approach for vehicle radars. The radar transmitter 1102/1103 on vehicle 1 and the radar transmitter on vehicle 2 1104/1105 may transmit the same or orthogonal waveforms. The radar receiver 1106/1107 on vehicle 3 receives the target-reflected signals from the transmitter 1102/1103 and 1106/1107. If vehicle 1 and vehicle 2 are internet-connected, Tx1 on vehicle 1, Tx2 on vehicle 2, and Rx on vehicle 3 will formulate a multistatic radar approach. All radar signals are utilized for target detection, estimation and tracking.

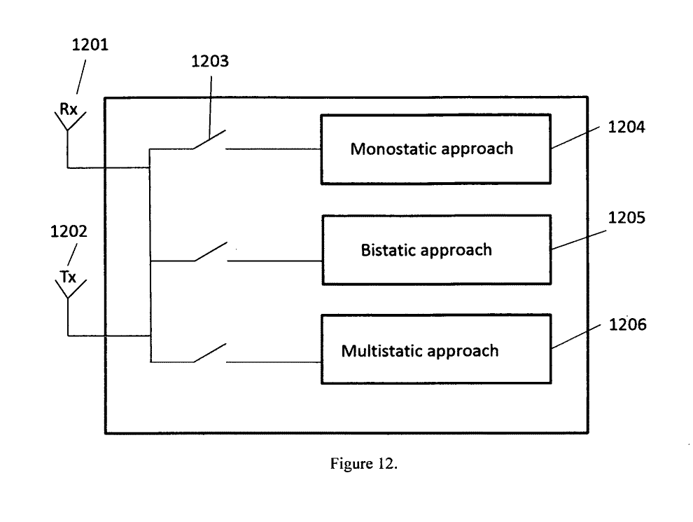

FIG. 12 is the polystatic approach for vehicle radars. The polystatic radar may work in any one of, or combination of, these three approaches: monostatic 1204, bistatic 1205, and/or multistatic 1206. It is determined by the vehicles nearby. If there is no vehicle nearby, the polystatic MIMO radar is reduced to the monostatic approach. If there is only one internet-connected vehicle nearby, the polystatic radar works as the combination of monostatic and bistatic approaches. If there are multiple internet-connected vehicles, the polystatic radar is the combination of monostatic and multistatic approaches. Space-Time-Waveform Adaptive Processing (STWAP) may be applied to improve the radar detection performance.

What is claimed:

1. A deep fusion system to provide inter-radar interference-free environmental perception, comprising:
a polystatic MIMO radar module to detect both cooperative and non-cooperative targets;
the internet-connection module (V2X (V2V, V2I, Vehicle-to-Pedestrian, Vehicle-to-Others), cellular network, data center/cloud, etc.) for information sharing between vehicles, or between vehicles and the infrastructure;
a self-localization/navigation module on each vehicle to estimation own states, which formulate a cooperative sensor by combination with V2X;
a passive sensor (EOIR) module to detect both cooperative and non-cooperative targets;
a multi-sensor registration and fusion module which estimates the sensor system bias including the clock offset, radar range/angle bias, camera extrinsic/intrinsic bias, etc, and fuses multiple sensors to provide better tracking performance;
a sensor management module which is responsible for the sensor resource management;
obstacle collision avoidance module.

2. A deep fusion system to provide inter-radar interference-free environmental perception as in claim 1, wherein the polystatic MIMO radar consists of multiple transmitter antennas/multiple receiver antennas, RF or LIDAR frontend, radar signal processing (matched filter, detection, range-doppler processing, angle estimation, association, and radar tracking), and the transmitters on different vehicles may be synchronized with the aid of GPS, network synchronization, or sensor registration method.

3. A deep fusion system to provide inter-radar interference-free environmental perception as in claim 1, wherein the internet-connection module which includes V2X, cellular network, data center/cloud, etc, can be combined together with the self-localization/navigation module for formulating cooperative sensors to only detect and track cooperative, internet-connected vehicles and/or other cooperative targets such as bicycles, pedestrian.

4. A deep fusion system to provide inter-radar interference-free environmental perception as in claim 1, may obtain helpful information (such as 3D map, vehicle types, sensor payload on each vehicle) from a data center/cloud through IoV.

5. A deep fusion system to provide inter-radar interference-free environmental perception as in claim 1, wherein the self-localization/navigation module estimates the platform position, velocity, attitude by fusion of GPS, IMU, barometer, digital map, visual navigation, etc.

6. The polystatic MIMO radar as in claim 2 is deeply fused with the cooperative sensors formulated by combination of the internet-connection module and the self-localization/navigation module, wherein provides:
detecting both cooperative and non-cooperative targets;
deep fusion in which the internal radar signal processing algorithms such as detection, range-velocity processing, angle estimation, association, tracking, are aided by the sharing messages from the cooperative sensors;
the polystatic MIMO radar approach where the radar signals transmitted from other vehicles are considered as useful signals, and used together with own radar signals.

7. The polystatic MIMO radar as in claim 2 has multiple work modes including:
the monostatic mode if Rx and Tx are located in the same place;
the bistatic mode if Rx and Tx are located on different vehicles;
the multistatic mode if multiple Transmitters are located on multiple vehicles;
the combination mode if some transmitters are located on the same place with Rx, while some transmitters are located on different places.

8. The polystatic MIMO radar as in claim 2 may use:
various orthogonal waveform for each radar in the following domain: frequency, time, code, polarization, etc;
the same waveform (FMCW or others) on the cooperative, internet-connected vehicles;

9. Multiple polystatic MIMO radars as in claim 2 may be deployed on the same vehicle for obstacle detection and tracking along different directions: forward-looking, backward-looking, and side-looking.

10. A deep fusion system to provide inter-radar interference-free environmental perception as in claim 1, wherein the passive sensor (EOIR) module provides an interference-free obstacle detection approach to both cooperative and non-cooperative targets.

11. A deep fusion system to provide inter-radar interference-free environmental perception as in claim 1, wherein the multi-sensor registration and fusion module provides two functions comprising of:
multi-sensor registration where the sensor system biases, such as the radar range bias, angle bias, camera extrinsic/intrinsic parameters, sensor clock offset, are estimated with the aid of cooperative sensors, and are applied to the internal radar signal processing algorithms and the multi-sensor fusion tracking module;
multi-sensor fusion tracking where the outputs of multiple sensors including polystatic MIMO radar, EOIR, cooperative sensors, and/or other sensors LIDAR are fused to provide accurate target tracking.

12. A deep fusion system to provide inter-radar interference-free environmental perception as in claim 1, wherein the sensor management module is responsible for managing the sensor resources including:
adaptively assigning the sensor resources such as frequency bands, time slots, orthogonal codes, and power to each radar;
assigning an orthogonal radar waveform to each radar to its best;
assigning the same radar waveforms to internet-connected vehicles if no orthogonal waveform is left.
